(19) United States
(12) Patent Application Publication
(10) Pub. No.: US 2003/0050214 A1
(43) Pub. Date: Mar. 13, 2003

(54) Home laundry method

(75) Inventors: William Michael Scheper, Lawrenceburg, IN (US); John Christian Haught, West Chester, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/238,292

(22) Filed: Sep. 10, 2002

Related U.S. Application Data
(60) Provisional application No. 60/318,395, filed on Sep. 10, 2001.

(51) Int. Cl. C11D 17/00

(52) U.S. Cl. 510/421; 510/506; 510/505; 510/466

(57) ABSTRACT

Automatic home laundering processes for cleaning and/or refreshing fabric articles, especially articles of clothing, linen and drapery is provided by the present invention. The present invention also relates to automatic home laundering of mixed loads of fabric articles comprising machine washable fabric articles and dry clean only fabric articles.

### RELATED APPLICATIONS

This application claims priority to U.S. Provisional Application Serial No. 60/318,395 filed Sep. 10, 2001.

### FIELD OF THE INVENTION

The present invention relates to automatic home laundering processes for cleaning and/or refreshing fabric articles, especially articles of clothing, linen and drapery. The present invention also relates to automatic home laundering of mixed loads of fabric articles comprising machine washable fabric articles and dry clean only fabric articles.

### BACKGROUND OF THE INVENTION

For centuries, fabric articles have been washed using water-based processes. In the last century, this home chore was greatly simplified by the development of the automatic washing machine. However, while greatly simplifying the home laundry process, even the home laundry process using the automatic washing machine still requires a significant amount of presorting fabric articles by color and textiles. Typically whites are washed separately from colored fabrics, and brightly colored fabric articles (e.g., dark reds and blues) from less highly colored articles. Further sorting and handling is required when the fabric articles to be laundered include “dry clean only” articles.

More recently, water conservation efforts and environmental concerns have driven laundry machine manufacturers and laundry detergent manufacturers to reduce the amount of water required in the home laundry process. However, such efforts have focused on reducing water consumption by the wash medium rather than changing the wash medium from a primarily water based process.

In parallel, concerns have arisen around the use of “Perc” (short for perchloroethylene) as the wash medium for the commercial dry cleaning process. These concerns have lead to the development of a significant number of proposed alternatives the Perc-based processes, but to date all other alternatives are still not widely used. Examples include hydrocarbons and liquid carbon dioxide. A recently proposed option as a replacement for Perc in the commercial dry cleaning field involves the use of glycol ethers as the cleaning solution for “dry clean only” fabric articles (see, for example, U.S. Pat. Nos. 5,888,250, Mar. 30, 1999; and 6,156,074 Dec. 5, 2000). A more recently proposed option as a replacement for Perc in the commercial dry cleaning field involves the use of DPtB (short for dipropyleneglycol-t-butyl ether) as the cleaning solution for “dry clean only” fabric articles (see, for example, U.S. Pat. No. 6,273,919 B1, Aug. 14, 2001)

It has been discovered by the present invention that further simplification of the automatic home laundry process and elimination of the reliance on a solely water based home laundry process are possible by using a DPtB based wash medium for the home laundry process. This process allows not only the home cleaning of a consumer's “dry clean only” fabric articles, but also those “machine wash” articles conventionally washed at home in a water wash medium. Further while the consumer may still opt to wash such articles separately, the present invention process allows the consumer the freedom to significantly simplify the home laundry process by washing mixed loads of “dry clean only” and “machine wash” articles, thereby greatly reducing the presorting effort.

### SUMMARY OF THE INVENTION

The present invention encompasses an automatic home laundry process comprising the step of cleaning fabric articles in an automatic washing machine in the home with a wash medium comprising a glycol ether, such as DPtB.

The present invention also relates to an automatic home laundry process comprising contacting, in an automatic washing machine, machine washable fabric articles with a wash medium comprising a glycol ether, such as DPtB. More preferred is the DPtB-containing wash medium comprising less than about 50% water, but in some preferred executions it is desired to include some amount of purposively added water preferably in the range of from about 0.1% to about 50% water by weight of the wash medium.

The present invention also relates to a DPtB containing wash medium comprising cosolvents selected from other glycol ethers (specifically propyleneglycol methyl ether (PM), dipropyleneglycol methyl ether (DPM), dipropylene glycol-n-propyl ether (DPnP), dipropyleneglycol-n-butyl ether (DPnB), tripropyleneglycol-n-propyl ether (TPnP), tripropyleneglycol-n-butyl ether (TPnB), propyleneglycol-n-butyl ether (PnB), propyleneglycol-n-propyl ether (PnP), propyleneglycol-t-butyl ether (PtB) and the like) and siloxanes, especially decamethyl-cyclopentasiloxane (pentamer, commonly referred to as “D5”). More preferred is the DPtB containing wash medium comprising less than 50% of these cosolvents, but in some preferred executions it is desired to include some amount of purposively added cosolvent preferably in the range of from about 0.1% to about 50%. Also preferred is a DPtB containing wash medium comprising less than about 0.5% by weight of di-tert-butyl ether impurities.

The present invention also relates to the addition of adjunct cleaning actives added to the DPtB cleaning fluid. These cleaning adjuncts are preferably in the range of from about 0.01% to about 2% by weight of the wash medium. Some suitable cleaning adjuncts are selected from DPtB soluble or dispersible builders, surfactants, enzymes, bleach activators, bleach catalysts, bleach boosters, bleaches, alkalinity sources, antibacterial agents, colorants, perfumes, pro-perfumes, finishing aids, lime soap dispersants, odor control agents, odor neutralizers, polymeric dye transfer inhibiting agents, crystal growth inhibitors, photobleaches, heavy metal ion sequestrants, anti-tarnishing agents, anti-microbial agents, anti-oxidants, anti-redeposition agents, soil release polymers, electrolytes, pH modifiers, thickeners, abrasives, divalent or trivalent ions, metal ion salts, enzyme stabilizers, corrosion inhibitors, diamines or polyamines and/or their alkoxylates, suds stabilizing polymers, solvents, process aids, fabric softening agents, optical brighteners, hydrotropes, suds or foam suppressors, suds or foam boosters and mixtures thereof. Preferably, these cleaning adjuncts are added immediately before or during the wash cycle and are removed after the wash cycle so that the DPtB solvent, alone or in combination with the cosolvent(s), is recovered for reuse in subsequent wash cycles.

Further preferred processes of the present invention are directed to an automatic home laundry process comprising contacting, in an automatic washing machine, a mixed load of fabric articles comprising machine washable and dry clean only fabric articles with a wash medium comprising DPtB.

These and other aspects, features and advantages will become apparent from the following detailed description and the appended claims. All percentages, ratios and proportions are by weight, and all temperatures are in degrees Celsius (° C.), unless otherwise specified. All measurements are in SI units unless otherwise specified, and all documents cited are in relevant part incorporated herein by reference in their entirety.

### DETAILED DESCRIPTION OF THE INVENTION

The term “fabric article”, as used herein, means any article that is customarily cleaned in a conventional laundry process or in a dry cleaning process. The term encompasses articles of clothing, linen and drapery, clothing accessories, and floor coverings. The term also encompasses other items made in whole or in part of fabric, such as tote bags, furniture covers, tarpaulins and the like.

The term “machine washable fabric articles”, as used herein, means those fabric articles readily identified by the fabric industry and consumers as safe for laundering by a conventional aqueous automatic home laundry process. Consumers are frequently helped in this identification of fabric articles by manufacturer's tags identifying the fabric article as “machine washable” or some similar description.

The term “dry clean only fabric articles”, as used herein, means those fabric articles readily identified by the fabric industry and consumers as unsafe for laundering by a conventional aqueous automatic home laundry process, and instead requiring special handling with a conventional non-aqueous solvent such as Perc. Again, consumers are frequently helped in this identification of fabric articles by manufacturer's tags indentifying the fabric article as “dry clean only” or some similar description.

The term “automatic home laundry process”, as used herein, means the laundry process as practiced by the consumer using an automatic washing machine, preferably located within the consumer's residence (herein referred to as the process being conducted “in the home”), but also including public laundromats whereby the consumer follows essentially the same laundry process as though the automatic washing machine were present in the home.

The term “wash medium”, as used herein, means the liquid [including but not limited to, fluid(s) and/or solution(s) and/or solvent(s) and/or emulsion(s)] which is used to wet the fabric articles in the wash load during the automatic home laundry process.

The phrase “dry weight of a fabric article” as used herein means the weight of a fabric article that has no intentionally added fluid weight.

The phrase “absorption capacity of a fabric article” as used herein means the maximum quantity of fluid that can be taken in and retained by a fabric article in its pores and interstices. Absorption capacity of a fabric article is measured in accordance with the following Test Protocol for Measuring Absorption Capacity of a Fabric Article.

Test Protocol for Measuring the Absorption Capacity of a Fabric Article

Step 1: Rinse and dry a reservoir or other container into which a DPtB will be added. The reservoir is cleaned to free it from all extraneous matter, particularly soaps, detergents and wetting agents.

Step 2: Weigh a “dry” fabric article to be tested to obtain the “dry” fabric article's weight.

Step 3: Pour 2L of a DPtB at ˜20C into the reservoir.

Step 4: Place fabric article from Step 2 into the DPtB-containing reservoir.

Step 5: Agitate the fabric article within the reservoir to ensure no air pockets are left inside the fabric article and it is thoroughly wetted with the DPtB.

Step 6: Remove the fabric article from the DPtB-containing reservoir.

Step 7: Unfold the fabric article, if necessary, so that there is no contact between same or opposite fabric article surfaces.

Step 8: Let the fabric article from Step 7 drip until the drop frequency does not exceed 1 drop/sec.

Step 9: Weigh the “wet” fabric article from Step 8 to obtain the “wet” fabric article's weight.

Step 10: Calculate the amount of DPtB absorbed for the fabric article using the equation below.

FA=(W−D)/D*100

where:

FA=fluid absorbed, % (i.e., the absorption capacity of the fabric article in terms of % by dry weight of the fabric article)

W=wet specimen weight, g

D=initial specimen weight, g

By the term “non-immersive” it is meant that essentially all of the fluid is in intimate contact with the fabric articles. There is at most minimal amounts of “free” wash liquor. It is unlike an “immersive” process where the washing fluid is a bath in which the fabric articles are either submerged, as in a conventional vertical axis washing machine, or plunged into, as in a conventional horizontal washing machine. The term “non-immersive” is defined in greater detail according to the following Test Protocol for Non-Immersive Processes. A process in which a fabric article is contacted by a fluid is a non-immersive process when the following Test Protocol is satisfied.

Test Protocol for Non-Immersive Processes

Step 1: Determine absorption capacity of a fabric specimen using Test Protocol for Measuring Absorption Capacity of a Fabric Article, described above.

Step 2: Subject a fabric article to a fluid contacting process such that a quantity of the fluid contacts the fabric article.

Step 3: Place a dry fabric specimen from Step 1 in proximity to the fabric article of Step 2 and move/agitate/tumble the fabric article and fabric specimen such that fluid transfer from the fabric article to the fabric specimen takes place (the fabric article and fabric specimen must achieve the same saturation level).

Step 4: Weigh the fabric specimen from Step 3.

Step 5: Calculate the fluid absorbed by the fabric specimen using the following equation:

FA=(W−D)/D*100

where:

FA=fluid absorbed, %

W=wet specimen weight, g

D=initial specimen weight, g

Step 6: Compare the fluid absorbed by the fabric specimen with the absorption capacity of the fabric specimen. The process is non-immersive if the fluid absorbed by the fabric specimen is less than about 0.8 of the absorption capacity of the fabric specimen.

Even though the present invention is described primarily in the context of a non-immersive process, immersive processes are within the scope of the present invention. By “immersive” as used herein, it is meant that some free standing, excess (above the absorption capacity of the fabric articles) DPtB and/or its co-solvents are in contact with the fabric articles being cleaned and/or treated by the processes of the present invention.

The term “siloxane”, as used herein, means silicone fluids which are non-polar and insoluble in water or lower alcohols. They are completely miscible in typical aliphatic and aromatic solvents, including the halogenated solvents, but are only partially miscible with the intermediate petrolium fractions such as naphthalenes. Linear siloxanes (see for example U.S. Pat. Nos. 5,443,747, and 5,977,040, both incorporated herein by reference in their entirety) and cyclic siloxanes are useful herein, including the cyclic siloxanes selected from the group consisting of octamethyl-cyclotetrasiloxane (tetramer), dodecamethyl-cyclohexasiloxane (hexamer), and preferably decamethyl-cyclopentasiloxane (pentamer, commonly referred to as “D5”). When silicones are used as cosolvents, the most preferred siloxane composition comprises more than about 50% cyclic siloxane pentamer, more preferably more than about 75%, most preferably at least about 90% of the pentamer. Also preferred are wash mediums comprising siloxanes which are a mixture of cyclic siloxanes having at least about 90% (preferably at least about 95%) pentamer and less than about 10% (preferably less than about 5%) tetramer and/or hexamer.

For the present invention process, the specific method for contacting the wash medium containing the DPtB with the fabric article may be any method which results in complete wetting of the fabric articles in the wash load by the automatic washing machine, in contrast to spot wetting and/or hand wetting of the fabric articles. This includes contacting the fabric articles in an immersive bath of the wash medium or, preferably, using lower volumes of wash medium as is possible by low volume wetting means such as spraying to uniformly wet the fabric articles. Most preferred is contacting the fabric articles using a method that comprises at least one non-immersive step whereby the fabric article is wetted with the wash medium (preferably by uniform spraying), for example only to the extent of less than about 500%, more preferably less than about 200% (even more preferably less than about 150%) to about 20%, more preferably to about 50% by dry weight of the fabric article in the wash load.

One aspect of the present invention involves the contacting of the fabric articles with a wash medium comprising less than about 50% water, more preferably less than about 30%, less than about 20%, less than about 10%, less than about 5%, less than about 1%, and most preferably no purposively added water. However, in another aspect of the present invention some amount of purposively added water is a part of the wash medium with the DPtB, including for example either immiscible with the DPtB or as an emulsion comprising DPtB, water, and an emulsifying agent. Preferably the water comprises from about 0.1% to about 50%, more preferably from about 0.1% to about 30%, from about 0.1% to about 20%, from about 0.1% to about 10%, from about 0.1% to about 5%, and from about 0.1% to about 1%.

Another aspect of the present invention involves contacting of the fabric articles with a wash medium comprising some amount of purposively added cosolvent as part of the wash medium with the DPtB, including for example either solvents miscible with the DPtB or as an emulsion comprising DPtB and cosolvent or water and an emulsifying agent. The cosolvent can be selected from any DPtB soluble solvent, preferably glycol ethers or siloxanes. The glycol ethers are preferably selected from specifically propyleneglycol methyl ether (PM), dipropyleneglycol methyl ether (DPM), dipropylene glycol-n-propyl ether (DPnP), dipropyleneglycol-n-butyl ether (DPnB), tripropyleneglycol-n-propyl ether (TPnP), tripropyleneglycol-n-butyl ether (TPnB), propyleneglycol-n-butyl ether (PnB), propyleneglycol-n-propyl ether (PnP), propyleneglycol-t-butyl ether (PtB). More preferably, the cosolvent is selected from DPtB soluble solvents with vapor pressures of less than 0.1 mmHg (at 20° C.). Preferably the cosolvent comprises from about 0.1% to about 50%, more preferably from about 0.1% to about 30%, from about 0.1% to about 20%, from about 0.1% to about 10%, and from about 0.1% to about 5%.

In accordance with the present invention, the fabric articles to be treated and/or cleaned may be contacted with an impinging gas at any time during the method of the present invention.

It is desirable that the fabric articles are contacted by an impinging gas at least prior to applying the cleaning fluid. The impinging gas facilitates the removal particulate soils from the fabric articles. Particulate soils can be successfully removed using gas flow. Particulate soils include any soil that is comprised of discrete particles. Nonlimiting examples of such particulate soils include clay, dust, dried mud, sand, cat fur, skin flakes or scales, dander, dandruff, hair from people or pets, grass seeds, pollen, burrs, and/or similar animal, mineral or vegetable matter which is insoluble in water.

By utilizing the impinging gas, “demand” on chemicals in the process for removing such particulate soils is reduced.

Typically, the impinging gas is flow from a gas source at a rate of from about 10 l/s to about 70 l/s and the gas contacts the fabric articles at a velocity of from about 1 m/s to about 155 m/s. It is desirable to mechanically agitate the fabric articles while the gas impinges on the fabric articles. Further, it is desirable to remove the gas, and particulate soils in the gas from the fabric articles at a rate sufficient to prevent the removed particulate soils from re-depositing upon the fabric articles.

In one embodiment of the present invention the gas is selected from the group consisting of air, nitrogen, ozone, oxygen, argon, helium, neon, xenon, and mixtures thereof, more preferably air, nitrogen, ozone, oxygen, argon, helium, and mixtures thereof, even more preferably still air, ozone, nitrogen, and mixtures thereof.

In another embodiment of the present invention the gas used in the method can be varied over time. For example air could be used at the start of the process, a mixture of air and ozone used in the middle stages of the process and air or nitrogen could be used at the end.

The gas used may be of any suitable temperature or humidity. Heat could be supplied to the gas electrically or by passing the gas over a gas flame, such as, is done in a conventional gas dryer. However, room temperature and humidity gas are preferred.

In one embodiment of the present invention two or more gases could be mixed in a mixing chamber before being used in the process. In another aspect of this embodiment of the present invention the gases could be delivered concurrently through different entry points and mix in-situ in the walled vessel. In another aspect of this embodiment of the present invention the gases supplied could exist as mixture and would not require any mixing chamber to achieve the required mixture of gas for the process.

In one embodiment of the present invention the gas could be available from storage, such as from pressurized containers. Alternatively, the gas used in the process could be obtained from the location where the process and device occur. For example, a pump, blower, or the like, may be used to supply air from the surrounding atmosphere for the process of the invention. A combination of gas available from storage and from the atmosphere is also envisioned.

In another embodiment of the present invention the gas can be obtained from a compressor. The compressor may be any compressor suitable for providing gas or gases, provided that they supply the gas to the apparatus within the required velocity and flow rate ranges. The compressors are linked to the gas inlet(s) by an appropriate fixture, such as a hose, pipe, tap, fixture or combinations thereof, to provide the inlet(s) with the gas or gases within the required velocity and flow rate ranges. Some typical compressors, which are suitable for providing gas or gases, include rotary screw compressors or two-stage electrical compressor. Another suitable type of compressor is the so-called “acoustical compressor”, such as those described in U.S. Pat. Nos. 5,020,977, 5,051,066, 5,167,124, 5,319,938, 5,515,684, 5,231,337, and 5,357,757, all of which are incorporated herein by reference. Typically, an acoustical compressor operates in the following fashion: A gas is drawn into a pulse chamber, such as air from the atmosphere, compressed, and then discharged as a high-pressure gas. The gas is compressed by the compressor sweeping a localized region of electromagnetic, for example microwaves, laser, infrared, radio etc, or ultrasonic energy through the gas in the pulse chamber at the speed of sound. This sweeping of the pulse chamber creates and maintain a high-pressure acoustic pulse in the gas. These acoustical compressors have many advantages over conventional compressors. For example, they have no moving parts besides the valves, operate without oil, and are much smaller than comparable conventional compressors.

In one embodiment of the present invention the gas is provided from a gas source at a rate of from about 10 l/s to about 70 l/s, more preferably, about 20 l/s to about 42 l/s, even more preferably about 25 l/s to about 30 l/s. The gas flow rate is measure by a flow meter place in the internal space of the vessel close to where the gas enters the vessel containing the clothes.

In one embodiment of the present invention the gas contacts the fabric articles at a velocity of from about 1 m/s to about 155 m/s, more preferably, about 50 m/s to about 105 m/s even more preferably about 75 m/s to about 105 m/s. The gas velocity is measure by a flow meter place in the internal space of the vessel close to where the gas enters the vessel containing the clothes.

The velocity at which the gas contacts the fabric articles and the flow rate of the gas are critical parameters. For example insufficient velocity means that the particulates are not removed from the fabric articles. Too great a velocity and the fabric articles are disrupted such that the fabric articles cannot be agitated and the particulate soils cannot be removed. Similarly, insufficient flow rate of the gas means that any particulate soils removed remain and can be re-deposited on the fabric article after cleaning.

Obviously the present invention process cannot use current conventional automatic washing machines as developed for aqueous wash processes. While automatic washing machines useful for the present process may be connected to a water source, such connection for purposes of carrying out the current process is solely for the supply of the optional purposively added water. A supply of the DPtB is necessary, preferably stored in a container for use in the current process and into which the DPtB is returned (following a suitable cleaning process) after contact with the fabric articles in the automatic home laundry process.

While an apparatus having the various components as defined for the immersive commercial dry cleaning process as described in U.S. Pat. No. 6,059,845, issued May 9, 2000, and U.S. Pat. No. 6,063,135, issued May 16, 2000 (both incorporated herein by reference in their entirety), if modified for residential size and consumer maintenance, could be used to practice the present invention process, an immersive process for the present invention is not preferred. Reasons include the constraints (versus the commercial dry cleaner size and operation taught in these patents) associated with supplying, storing and cleaning larger volumes of DPtB in the home.

For these reasons lower volume processes such as those utilizing a uniform spray process which completely wets the fabric articles with the lower volumes of wash medium as described herein before are highly preferred. For example modifications of conventional low water wash appliances to deliver low levels of DPtB-containing wash medium rather than a water wash medium should be considered; such conventional water wash appliances are described for example in U.S. Pat. Nos. 4,489,574; 4,489,455; 5,191,669; 5,191,668; 5,233,718; and 5,671,494, all incorporated herein by reference in their entirety. A most preferred automatic washing machine useful for this low volume process is described in detail in the co-filed, copending patent application, P&G Case 8119P, incorporated herein by reference in its entirety. Further preferred are automatic washing machines which guarantee homogeneous coverage of the fabric articles with the DPtB-containing wash medium by intermittent spin and spray followed by random tumbling until all the wash medium has been sprayed. Also preferred are such machines which reuse the DPtB-containing wash medium via an immediate re-use/recycling action, for example by passing the wash medium over a particle removal filter after extraction from the fabric articles and then immediately spraying it back onto the fabric articles.

Further preferred automatic washing machines for practicing the present invention processes are designed to also dry the fabric articles in the same apparatus. This not only allows the consumer the convenience of not having to handle the wet fabric articles but also permits recovery of all the DPtB for reuse or cleaning.

It is also envisioned that adjuncts for cleaning and/or treating the fabric articles according to the desires of the consumer may be added to the process. The automatic washing machine therefore preferably includes recepticals for receiving and/or dispensing such adjuncts into the automatic laundry process at the desired time, either with the wash medium or separate from it. Cartridges containing such adjuncts (either through refilling or purchased with the adjunct) which releaseably attach to the machine are also optional executions. Preferred adjuncts include surfactants, cleaning polymers, brighteners, enzymes, bleaches, soil release polymers, softeners, dye fixatives, abrasion resistant agents, and anti-wrinkle agents. Preferably, these cleaning adjuncts are added immediately before or during the wash cycle and are removed after the wash cycle so that the DPtB solvent, alone or in combination with the cosolvent(s), is recovered for reuse in subsequent wash cycles. A particularly preferred adjunct is any material which functions as an antistatic agent when combined with the DPtB-containing wash medium in the present automatic home laundry process.

An additional preferred feature of the automatic washing machine is the ability to clean and reuse the DPtB for more than one automatic laundry process. A preferred means for cleaning the DPtB for multiple uses is a replaceable filter. Such filter should preferably include filter materials capable of removing and collecting at least the body soils removed from the fabric articles during the automatic home laundry process. Activated charcoal, silicas, molecular seives, and/or hydrophobically modified papers are just some optional components of such filters. The attachment to the automatic washing machine is preferably by means such that the consumer can readily replace it at regular intervals.

What is claimed is:

1. An automatic home laundry process, said process comprising the step of cleaning fabric articles in an automatic washing machine in the home with a wash medium comprising a glycol ether.

2. The automatic home laundry process according to claim 1 wherein the glycol ether is selected from the group consisting of PM, DPM, PtB, PnP, PnB, DPnP, DPnB, TPnP, TPnB, and combinations thereof.

3. The automatic home laundry process according to claim 1, said glycol ether comprising DPtB.

4. The automatic home laundry process according to claim 1 wherein the fabric articles cleaned comprise fabric articles selected from the group consisting of machine washable fabric articles, dry clean only fabric articles, and combinations thereof.

5. The automatic home laundry process according to claim 1 wherein the fabric articles are contacted with the wash medium comprising DPtB by uniformly wetting by spraying the wash medium onto the fabric articles in the automatic washing machine.

6. The automatic home laundry process according to claim 1 wherein the wash medium comprises no purposively added water.

7. The automatic home laundry process according to claim 1 wherein the wash medium comprises from about 0.1% to about 50% purposively added water.

8. The automatic home laundry process according to claim 1 wherein the wash medium comprises from about 0.1% to about 50% of a cosolvent selected from the group consisting of siloxanes, other glycol ethers, and mixtures thereof.

9. The automatic home laundry process according to claim 8 wherein the siloxane comprises cyclic siloxane.

10. The automatic home laundry process according to claim 9 wherein the cyclic siloxane comprises more than about 50% cyclic siloxane pentamer.

11. The automatic home laundry process according to claim 8 wherein the other glycol ether is selected from the group consisting of PM, DPM, PtB, PnP, PnB, DPnP, DPnB, TPnP, TPnB, and combinations thereof.

12. The automatic home laundry process according to claim 1 wherein the wash medium comprises from about 0.1% to about 50% of a cosolvent wherein the vapor pressure of the wash medium is less than 0.1 mmHg.

13. An automatic home laundry process, said process comprising contacting, in an automatic washing machine, machine washable fabric articles with a wash medium comprising DPtB.

14. The automatic home laundry process according to claim 13 wherein the wash medium comprises less than about 50% water.

15. The automatic home laundry process according to claim 14 wherein the wash medium comprises no purposively added water.

16. The automatic home laundry process according to claim 13 wherein the wash medium comprises from about 0.1% to about 50% purposively added water.

17. The automatic home laundry process according to claim 13 wherein the fabric articles contacted with the wash medium further comprise dry clean only fabric articles.

18. The automatic home laundry process according to claim 13 wherein the wash medium comprises from about 0.1% to about 50% of a cosolvent selected from the group consisting of siloxane, glycol ether, and combinations thereof.

19. The automatic home laundry process according to claim 18 wherein the siloxane comprises cyclic siloxane.

20. The automatic home laundry process according to claim 19 wherein the cyclic siloxane comprises more than about 50% cyclic siloxane pentamer.

21. The automatic home laundry process according to claim 18 wherein the glycol ether is selected from the group consisting of PM, DPM, PtB, PnP, PnB, DPnP, DPnB, TPnP, TPnB, and combinations thereof.

22. The automatic home laundry process according to claim 13 wherein the wash medium comprises from about 0.1% to about 50% of a cosolvent wherein the vapor pressure of the wash medium is less than 0.1 mmHg.

23. An automatic home laundry process, said process comprising contacting, in an automatic washing machine in the home, machine washable fabric articles and dry clean only fabric articles with a wash medium comprising DPtB.

24. The automatic home laundry process according to claim 23 wherein the wash medium comprises from about 0.1% to about 50% of a cosolvent selected from the group consisting of siloxane, glycol ether, and combinations thereof.

25. The automatic home laundry process according to claim 24 wherein the siloxane comprises cyclic siloxane.

26. The automatic home laundry process according to claim 25 wherein the cyclic siloxane comprises more than about 50% cyclic siloxane pentamer.

27. The automatic home laundry process according to claim 23 wherein the glycol ether is selected from the group consisting of PM, DPM, PtB, PnP, PnB, DPnP, DPnB, TPnP, TPnB, and combinations thereof.

28. The automatic home laundry process according to claim 27 wherein the wash medium comprises from about 0.1% to about 50% of a cosolvent wherein the vapor pressure of the wash medium is less than 0.1 mmHg.

29. The automatic home laundry process according to claim 23 wherein the fabric articles are contacted with the wash medium comprising DPtB by uniformly wetting by spraying the wash medium onto the fabric articles in the automatic washing machine.

30. The automatic home laundry process according to claim 23 wherein the wash medium comprises from about 0.1% to about 5% purposively added water.

31. The automatic home laundry process according to claim 1 wherein the DPtB comprises less than about 0.5% by weight of di-tert-butyl ether impurities.

32. The automatic home laundry process according to claim 1 wherein the DPtB comprises from about 1% to 25% by weight of di-tert-butyl ether or dipropylene glycol impurities.

33. An automatic laundry process, said process comprising the step of cleaning fabric articles in an automatic washing machine in the home with a wash medium comprising glycol ethers and a solvent clean-up step comprising filtration but excluding steam distillation.

34. The automatic home laundry process according to claim 1, said process comprising the step of cleaning fabric articles in an automatic washing machine in the home with a wash medium comprising glycol ethers, with at least one washing step where the wash fluid is applied to the fabric articles in a non-immersive process.

35. The automatic home laundry process according to claim 33, said process comprising the step of cleaning fabric articles in an automatic washing machine in the home with a wash medium comprising glycol ethers, wherein the wash medium to fabric weight ratio is less than 5 to 1.
